(19) United States
(12) Patent Application Publication
(10) Pub. No.: US 2019/0269165 A1
(43) Pub. Date: Sep. 5, 2019

(54) METHOD FOR PREPARING BEVERAGE COMPOSITION INCLUDING ROSA RUGOSE THUNB. EXTRACT

(71) Applicant: ONGJIN-GUN, Michuhol-gu (KR)

(72) Inventors: Sam-Dong HAN, Yeonsu-gu (KR); Chun-Su HA, Dong-gu (KR); Min-Hui SUN, Michuhol-gu (KR)

(73) Assignee: ONGJIN-GUN, Michuhol-gu (KR)

(21) Appl. No.: 16/195,032

(22) Filed: Nov. 19, 2018

(30) Foreign Application Priority Data
Mar. 5, 2018 (KR) 10-2018-0026019

(51) Int. Cl. A23L 33/105; A23L 5/00; A23L 2/56; A23F 3/34; B01D 11/02; B65D 85/808

(52) U.S. Cl. CPC A23L 33/105; A23L 5/51; A23L 2/56; A23V 2002/00; B01D 11/0288; B65D 85/808; A23F 3/34

(57) ABSTRACT

The present invention relates to a beverage including a Rosa rugosa Thunb. extract and a method for producing the same. The beverage including the Rosa rugosa Thunb. extract of the present invention is expected to have high preference and a high nutraceutical property, and contribute to the increase in local income through industrial production.

### CROSS-REFERENCE TO RELATED APPLICATION

This application claims priority to and the benefit of Korean Patent Application No. 2018-0026019, filed on Mar. 5, 2018, the disclosure of which is incorporated herein by reference in its entirety.

### BACKGROUND

### 1. Field of the Invention

The present invention relates to a beverage composition including a Rosa rugosa Thunb. extract and a method for preparing the same.

### 2. Discussion of Related Art

Rosa rugosa Thunb. is a summergreen shrub which belongs in the genus Rosa and the family Rosaceae, Rosa rugosa Thunb. is native to coastal regions, and widely distributed from a temperate region of eastern Asia such as Japan, Korea and China to a subpolar region such as the Kamchatka Peninsula and Okhotsk coast. Rosa rugosa Thunb. tolerates harsh environments such as pollution and cold well and has low soil selectivity, and therefore is widely planted for gardening.

The flowers have been used as a raw material for tea or fragrance, and the hips have been used in processed food such as jam. On the other hand, Rosa rugosa Thunb. has long been used for the treatment of gastric pain, hematemesis, hypermenorrhea or diarrhea in China, and for the treatment and prevention of diabetes in Korea and Japan as folk medicine.

It has been revealed that there are a rich content of vitamin C, terpenoids and phenylpropanoids, flavonoids such as quercetin, isoquercetin, rutin, etc., hydrolyzable tannins such as tellimagrandin I, tellimagrandin II, rugosin, etc., and condensed tannins such as catechin, catechin derivatives, etc. in Rosa rugosa Thunb. Such ingredients are involved in various physiological activities, and there are studies reporting that Rosa rugosa Thunb. is effective for antiinflammation, sedation, antiallergy, anti-hyperlipemia, prevention of skin aging, whitening, and treatment of diabetes. Particularly, it also has been reported that hydrolyzable tannins such as tellimagrandin I and pedunculagin not only have an effect of inhibiting the activity of HIV or HTLV-1 transcriptase, but also have effects of inhibiting the growth of cancer cells in vitro and promoting the growth of immunocytes. As described above, Rosa rugosa Thunb. is deeply involved in various physiological activities, and thus is used in functional food and is attracting attention as a pharmaceutical material.

The present invention is directed to providing a method for producing a Rosa rugosa Thunb. beverage containing a Rosa rugosa Thunb. hip extract produced in Onjin-gun, and a high value-added beverage product prepared by mixing supplementary materials or oriental medicinal materials with the Rosa rugosa Thunb. hip extract to satisfy consumers' demands for preference and a nutraceutical property.

### SUMMARY OF THE INVENTION

The present invention is directed to providing a food composition including a Rosa rugosa Thunb. extract and a method for preparing the same.

To achieve the object of the present invention, a method for preparing a food composition including a Rosa rugosa Thunb. hip extract is provided, the method including i) to iv) steps as below:

i) washing Rosa rugosa Thunb. hips with water and hot-air drying the washed hips;

ii) coarsely grinding the hot-air dried Rosa rugosa Thunb. hips prepared in Step i);

iii) obtaining a Rosa rugosa Thunb. hip extract by extracting and concentrating the coarsely ground Rosa rugosa Thunb. hips prepared in Step ii) with a solvent; and

iv) preparing a homogenized and mixed beverage by adding supplementary materials including high fructose, citric acid, a flavor and purified water to the Rosa rugosa Thunb. hip extract obtained in Step iii).

In an exemplary embodiment of the present invention, the solvent in Step iii) may be water, ethyl alcohol or a mixture thereof.

In an exemplary embodiment of the present invention, the concentration in Step iii) may be concentration of the extract until a sugar content becomes 2 to 6° Bx.

In an exemplary embodiment of the present invention, as the supplementary materials in Step iv), 5 to 120 parts by weight of high fructose, 0.1 to 3 parts by weight of citric acid, 0.01 to 0.05 part by weight of a flavor, and 50 to 1000 parts by weight of purified water may be included with respect to 100 parts by weight of the Rosa rugosa Thunb. hip extract, wherein the flavor may be any one or more selected from the group consisting of a pineapple flavor, a lemon flavor, a citron flavor, a black tea flavor and an apple flavor.

In addition, the present invention provides a method for preparing a food composition including a Rosa rugosa Thunb. hip extract, the method including Steps i) to iv) as below:

i) washing Rosa rugosa Thunb. hips with water and hot-air drying the washed hips;

ii) coarsely grinding the hot-air dried Rosa rugosa Thunb. hips prepared in Step i);

iii) obtaining a Rosa rugosa Thunb. hip extract by extracting and concentrating the coarsely ground Rosa rugosa Thunb. hips prepared in Step ii) with a solvent; and

iv) preparing a homogenized and mixed beverage by adding oriental medicinal materials such as including dry jujube, dry ginger and licorice to the Rosa rugosa Thunb. hip extract obtained in Step iii).

In an exemplary embodiment of the present invention, the solvent in Step iii) may be water, ethyl alcohol or a mixture thereof.

In an exemplary embodiment of the present invention, the concentration in Step iii) may be concentration of the extract until a sugar content becomes 2 to 6° Bx.

In an exemplary embodiment of the present invention, the oriental medicinal materials in Step iv) may include 1 to 10 parts by weight of dry jujube, 0.1 to 1.5 parts by weight of dry ginger, and 0.1 to 1.5 parts by weight of licorice with respect to 100 parts by weight of the Rosa rugosa Thunb. hip extract.

In addition, the present invention provides a Rosa rugosa Thunb. food composition, which is prepared by the method for preparing a food composition.

In an exemplary embodiment of the present invention, the food composition may be a beverage composition.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 shows morphological characteristics of the front and sectional shapes of Rosa rugosa Thunb. hips, which are prepared by freezing, hot-air drying and lyophilizing fresh hips, and the forms of ground products thereof;

FIG. 2 shows a water extract of Rosa rugosa Thunb. (left) and an ethyl alcohol extract of Rosa rugosa Thunb. (right);

FIG. 3 shows a concentrate of the water extract of Rosa rugosa Thunb. (left) and a concentrate of the ethyl alcohol extract of Rosa rugosa Thunb. (right);

FIG. 4 shows the change in soluble solids per extraction solvent over time;

FIG. 5 shows test products of a Rosa rugosa Thunb. beverage;

FIG. 6 shows pouch-type test products of a Rosa rugosa Thunb. beverage;

FIG. 7 shows tea bag-type test products of a Rosa rugosa Thunb. beverage, for example, a hot-air dried tea bag (left) and a lyophilized tea bag (right); and

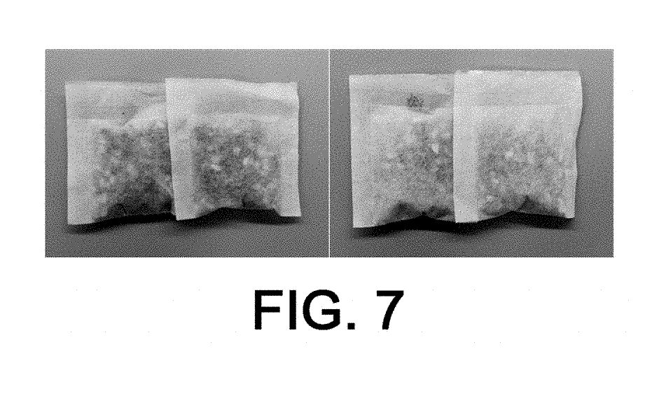

FIG. 8 is a schematic diagram illustrating a process of producing a Rosa rugosa Thunb. beverage.

### DETAILED DESCRIPTION OF EXEMPLARY EMBODIMENTS

Hereinafter, the present invention will be described in detail.

The present invention provides a method for preparing a food composition including a Rosa rugosa Thunb. hip extract, the method including i) to iv) steps as below:

i) washing Rosa rugosa Thunb. hips with water and hot-air drying the washed hips;

ii) coarsely grinding the hot-air dried Rosa rugosa Thunb. hips prepared in Step i);

iii) obtaining a Rosa rugosa Thunb. hip extract by extracting and concentrating the coarsely ground Rosa rugosa Thunb. hips prepared in Step ii) with a solvent; and

iv) preparing a homogenized and mixed beverage by adding supplementary materials including high fructose, citric acid, a flavor and purified water to the Rosa rugosa Thunb. hip extract obtained in Step iii).

In the method of the present invention, the solve in Step iii) may be water, ethyl alcohol or a mixture thereof, but the present invention is not limited thereto, and any material that is used as a solvent for preparing an extract in the art for the purpose of extracting a water-soluble material may be used without limitation. The ethyl alcohol may be easily understood by those of ordinary skill in the art as edible ethanol. In the method of the present invention, the ethyl alcohol is preferably a 50 to 70% aqueous ethyl alcohol solution, that is, more preferably, a 50 to 70% ethanol aqueous solution.

In the method of the present invention, the concentration in Step iii) is preferably concentration of the extract until a sugar content becomes 2 to 6° Bx, but the present invention is not limited thereto. Specifically, it is more preferable that the sugar content of the extract is adjusted to 5° Bx in terms of being able to satisfy the consumers' preference for the sugar content of the beverage.

In the method of the present invention, as the supplementary materials in Step iv), high fructose, citric acid, a flavor and purified water may be used. The flavor may be any one selected from the group consisting of a pineapple flavor, a lemon flavor, a citron flavor, a black tea flavor and an apple flavor, and to give a proper favor and taste which is harmonized with the flavor of Rosa rugosa Thunb. according to consumers' preferences, a lemon flavor and a black tea flavor are most preferably used. A mixing ratio of the supplementary materials may be freely selected within the ranges of 5 to 120 parts by weight of high fructose, 0.1 to 3 parts by weight of citric acid, 0.01 to 0.05 part by weight of a flavor, and 50 to 1000 parts by weight of purified water with respect to 100 parts by weight of the Rosa rugosa Thunb. hip extract. More specifically, as optimal mixing ratios for producing a beverage satisfying customers' preferences, with respect to 100 parts by weight of the Rosa rugosa Thunb. hip extract, 5 to 120 parts by weight of high fructose, 0.1 to 3 parts by weight of citric acid, 0.005 to 0.02 part by weight of a lemon flavor, 0.005 to 0.01 part by weight of a black tea flavor, and 100 to 300 parts by weight of purified water are most preferable, but the present invention is not limited thereto.

In addition, the present invention provides a method for preparing a food composition including a Rosa rugosa Thunb. hip extract, the method including i) to iv) steps as below:

i) washing Rosa rugosa Thunb. hips with water and hot-air drying the washed hips;

ii) coarsely grinding the hot-air dried Rosa rugosa Thunb. hips prepared in Step i);

iii) obtaining a Rosa rugosa Thunb. hip extract by extracting and concentrating the coarsely ground Rosa rugosa Thunb. hips prepared in Step ii) with a solvent; and

iv) preparing a homogenized and mixed beverage by adding oriental medicinal materials such as including dry jujube, dry ginger and licorice to the Rosa rugosa Thunb. hip extract obtained in Step iii).

In the present invention, the solvent and a degree of concentration in Step iii) may be applied in the same manner as described above.

In the method of the present invention, as the oriental materials in Step iv), dry jujube, dry ginger and licorice may be used. Mixing ratios of the oriental medicinal materials may be freely selected within the ranges, for example, with respect to 100 parts by weight of the Rosa rugosa Thunb. hip extract, 1 to 10 parts by weight of dry jujube, 0.1 to 1.5 parts by weight of dry ginger, and 0.1 to 1.5 parts by weight of licorice. More specifically, as optimal mixing ratios for producing a beverage satisfying customers' preferences, with respect to 100 parts by weight of a Rosa rugosa Thunb. hip extract, 2.5 to 5 parts by weight of dry jujube, 0.5 to 1 part by weight of dry ginger and 0.001 to 0.003 part by weight of licorice are most preferable, but the present invention is not limited thereto.

Moreover, the present invention provides a Rosa rugosa Thunb. food composition prepared according to the method for preparing a food composition.

In the food composition of the present invention, the food composition may be a beverage composition or produced in the form of a pouch-type tea bag, but the present invention is not limited thereto.

When the food composition including the Rosa rugosa Thunb. extract is produced in a pouch-type tea bag, for drinking, the food composition may be ingested as a tea after brewing the tea bag in water of 60□ or more for 3 to 5 minutes.

Hereinafter, the present application will be described in further detail with reference to examples. The examples are merely provided to more fully describe the present application, and it will be obvious to those of ordinary skill in the art that the scope of the present application is not limited to the following examples.

1. Materials

Rosa rugosa Thunb. hips used in this experiment were obtained from Onjin-gun in Incheon Metropolitan City in October, 2017. Some of them were washed thoroughly and hot-air dried at 50 □, and the remainder was kept frozen at −20□ to be used as a sample for extraction. Flavors used in the experiment were purchased from ES Ingredients Co., Ltd., and white sugar and citric acid were purchased commercially.

2. Experimental Methods

2-1. Physicochemical Properties

The pH of Rosa rugosa Thunb. hips was measured using a pH meter (Thermo Scientific Orion Star A211, USA) after a sample was well ground and a predetermined amount of the ground sample was put into a beaker.

The chromaticity of the Rosa rugosa Thunb. hips was expressed as an average value by measuring color measurement units such as L (lightness), a (redness/greenness) and b (yellowness/blueness) five times using a chromameter (CR-400 Minolta Co., Japan) calibrated with a standard white plate (L=97.75, a=−0.49, b=1.96).

ΔL: Difference of lightness

Δa: Difference of (redness/greenness)

Δb: Difference of (yellowness/blueness)

The sugar content of the Rosa rugosa Thunb. hips in the sample was determined in ° Bx using a refractometer (ATAGO Digital Refractometer, Japan).

The acidity of the Rosa rugosa Thunb. hips was calculated by converting an amount of a 0.1 N NaOH solution used when 20 mL of the sample was titrated with 0.1 N NaOH up to pH 8.4 using Orion Star A211 (Thermo, USA) into an amount of citric acid.

Proximate analysis of the Rosa rugosa Thunb. hips was performed according to methods in the Korean Food Standards Codex. A water content was analyzed by an air-oven method, a lipid content was analyzed by an ether extraction method, a protein content was analyzed by a Kjeldahl method, an ash content was analyzed by an ash testing method, and a carbohydrate content was analyzed by a calculation method.

For an organic acid, free sugar analysis and sample preparation, 5 g of Rosa rugosa Thunb. was put into a homogenizer, 20 mL of 80% ethanol was added thereto and homogenized, the homogenate was transferred to a 250 mL volumetric flask, 80 mL of 80% ethanol (v/v) was added thereto, and then the resulting solution was connected to a reflux condenser. After reflux extraction was carried out in a water bath for three hours, centrifugation was carried out at 6,000 rpm (650×g) for 30 minutes, and filtration was carried out with a filter paper (Whatman No. 1, Sigma-Aldrich, St. Louis, Mo., USA). The filtrate was completely volatilized with ethanol using a rotary concentrator to be concentrated to approximately 1 mL, and then diluted to a volume of 10 mL with distilled water. 3 mL of the resulting solution was filtered using a 0.45 μm membrane filter so as to be used as a sample for analyzing an organic acid and free sugar.

The sensory evaluation of the present invention was performed by 10 trained sensory agents, and on the intensity and preference of each sensory characteristic was evaluated with a 9-point scale.

### EXAMPLE 1

Quality Characteristics of Rosa rugosa Thunb. Hip Native to Onjin-Gun

1-1. Physical and Morphological Characteristics of Rosa rugosa Thunb. Hips

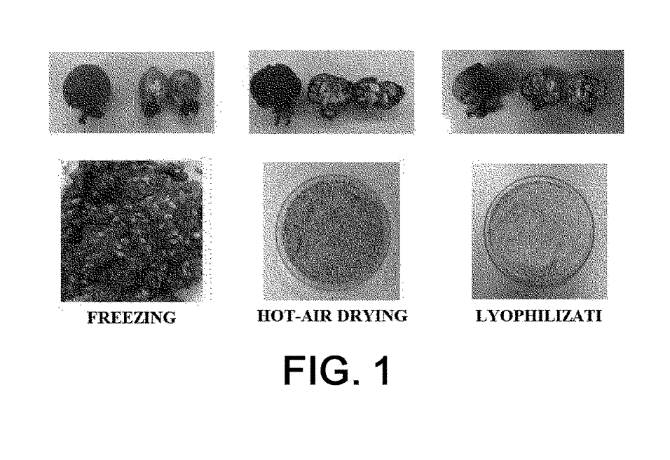

As the physical characteristics of the Rosa rugosa Thunb. hips, the average weight of a frozen hip was 4.01 g, the average weight of a hot-air dried hip was 1.40 g, and the average weight of a lyophilized hip was 1.64 g. FIG. 1 shows the morphological characteristics of the front and cross-sectional views of the hips by freezing, hot-air drying and lyophilizing fresh hips and the form of ground products thereof.

1-2. Yields by Method for Drying Rosa rugosa Thunb. Hip

The yields of hot-air dried and lyophilized fresh Rosa rugosa Thunb. hips were 34.72% and 39.81%, respectively (Table 1).

TABLE 1
Dry yield of fresh Rosa rugosa Thunb.

| Drying method | Yield (%) |
|---|---|
| Hot-air drying | 34.72 |
| Lyophilization | 39.81 |

1-3. Proximate Analysis of Fresh Rosa rugosa Thunb. Hips

The general composition of a fresh Rosa rugosa Thunb. hips is shown as in Table 2. In the Rosa rugosa Thunb. fresh hip, the water content was 65.9%, the lipid content was 0.8%, the protein content was 3.4%, the ash content was 1.2%, and carbohydrate content was 28.7%.

TABLE 2
General composition of fresh Rosa rugosa
Thunb. hips (units: g/100 g)

| Water | Lipid | Protein | Ash | Carbohydrate |
|---|---|---|---|---|
| 65.9 | 0.8 | 3.4 | 1.2 | 28.7 |

1-4. Organic Acid Characteristic of Fresh Rosa rugosa Thunb. Hips

The organic acid content in the fresh Rosa rugosa Thunb. hips was analyzed by HPLC, and a comparative analysis result is shown in Table 3. Citric acid, malic acid, succinic acid and oxalic acid were detected in the fresh Rosa rugosa Thunb. hips. Among the organic acids in the fresh Rosa rugosa Thunb. hips, citric acid was detected at the highest concentration, i.e., 0.3%, and the other organic acids including oxalic acid, malic acid and succinic acid were detected at 0.1%.

TABLE 3
Contents of organic acids in fresh Rosa rugosa
Thunb. hips (units: g/100 g)

| Citric acid | Malic acid | Succinic acid | Oxalic acid |
|---|---|---|---|
| 0.3 | 0.1 | 0.1 | 0.1 |

1-5. Free Sugar Characteristic of Fresh Rosa rugosa Thunb. Hips

Table 4 shows the contents of free sugars in fresh Rosa rugosa Thunb. hips. Only fructose and sucrose were detected, and the sucrose was the highest at 0.7%, and the fructose was detected at 0.2%.

TABLE 4
Contents of free sugars in fresh Rosa rugosa
Thunb. hips (units: g/100 g)

| Fructose | Glucose | Lactose | Sucrose | Maltose |
|---|---|---|---|---|
| 0.2 | 0.0 | 0.0 | 0.7 | 0.0 |

### EXAMPLE 2

Pretreatment Test for Rosa rugosa Thunb. Hips

For grinding and juice extraction tests on the fresh Rosa rugosa Thunb. hips, the fresh Rosa rugosa Thunb. hips were stored in a refrigerator at −20□, thawed and ground to obtain a juice, but the resulting ground product was hardly extracted as a paste. Therefore, to obtain a juice, 100 g of the fresh Rosa rugosa Thunb. hips were put into a household grinder, purified water was added at a weight five-fold larger than the fresh hip weight, and the mixture was sufficiently ground while rotating at a high speed. The sugar content, acidity and pH of a juice obtained by putting the previously-obtained solution on a filter cloth and performing squeeze-filtration (Table 5). The sugar content was 3.0° Bx, the acidity was 0.52%, and the pH was 4.40.

TABLE 5
Physicochemical characteristics of fresh Rosa rugosa Thunb. hips

| Characteristic | Sugar content (° Bx) | Acidity (%) | pH |
|---|---|---|---|
| Fresh Rosa rugosa Thunb. | 3.0 | 0.52 | 4.40 |
| hips | | | |

### EXAMPLE 3

Extraction Characteristic by Solvent

3-1. Water Extraction Characteristic

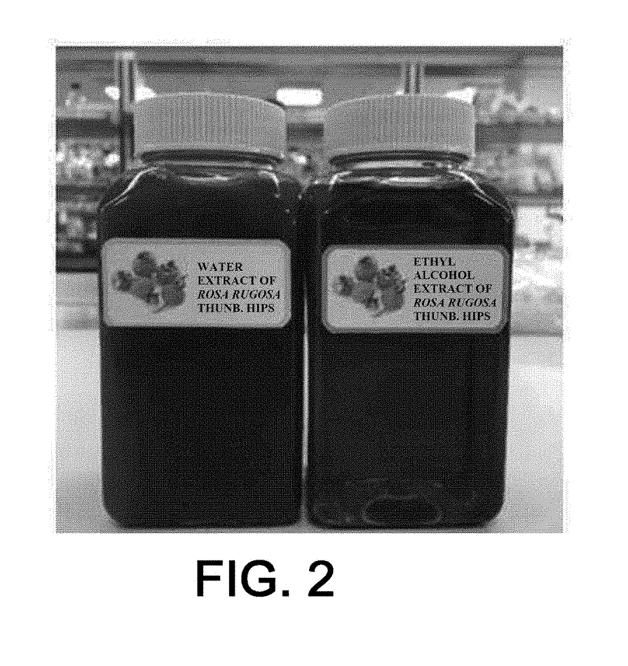

To improve an extraction yield, hot-air dried Rosa rugosa Thunb. hips were coarsely ground, and extraction was performed on 200 g of a sample with a weight of water 10-fold larger than the sample weight in an extraction flask equipped with a vertical reflux condenser. Soluble solids were examined at intervals of 1 hour after the extraction until the soluble solids no longer increased (FIG. 2).

3-2. Extraction Characteristic of Ethyl Alcohol

To improve an extraction yield, hot-air dried Rosa rugosa Thunb. hips were coarsely ground, and extraction was performed on 200 g of a sample with an amount of 70% ethyl alcohol 10-fold larger than the sample weight in an extraction flask equipped with a vertical reflux condenser. The soluble solids were examined by the same method as used in the water extraction (FIG. 2).

3-3. Production of Liquid Concentrate Product

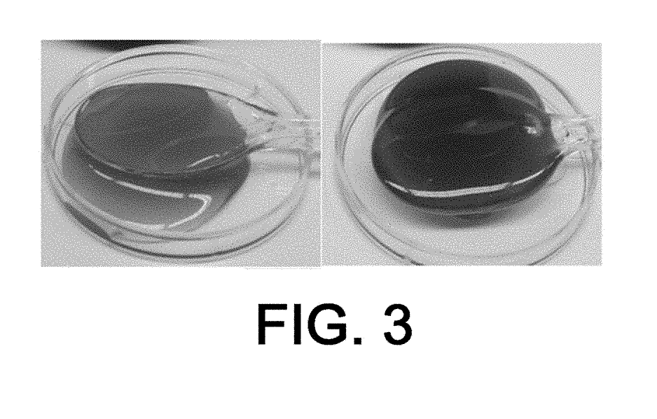

FIG. 3 shows vacuum-evaporated concentrates of the water extract and ethyl alcohol extract of Rosa rugosa Thunb., which are obtained at 65° BX or more in a rotary concentrator.

3-4. Change in Soluble Solids by Extraction Time

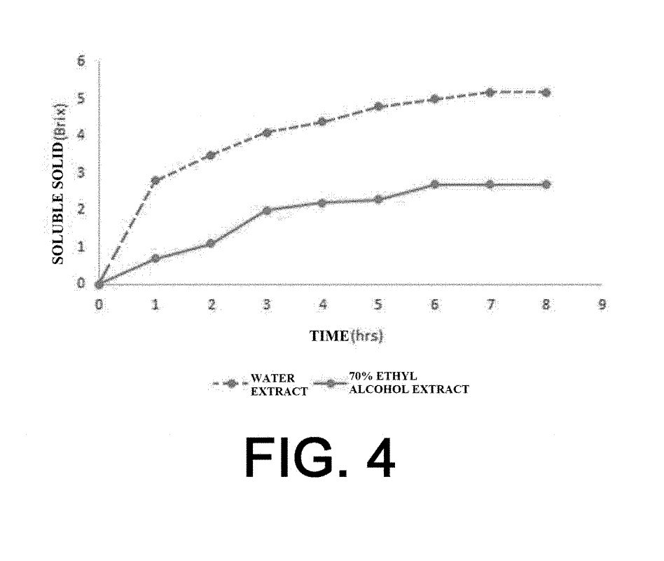

A change in soluble solids was examined by time zone by reflux extracting coarsely ground Rosa rugosa Thunb. hips with a 10-fold larger weight of each of water and 70% ethyl alcohol (FIG. 4).

In FIG. 4, one hour after the extraction, a water extract was rapidly increased up to approximately 3° Bx, gradually increased afterward, and increased up to approximately 5° Bx at 7 hours after the extraction to become the highest concentration of the soluble solids.

As the 70% ethyl alcohol extract was drastically increased until three hours after the extraction, the sugar content became approximately 2° Bx, and 6 hours after the extraction, the concentration was slowly increased to approximately 2.5° Bx, and then the extract was no longer obtained.

Water extraction had a higher extraction speed than ethyl alcohol extraction, and a higher concentration of the soluble solids was extracted. It is assumed that this is because water-soluble materials such as sugars, organic acids and starches in the hips are solubilized by heating and thus extracted more.

The water extract was sweeter and had a mild flavor compared to the ethyl alcohol extract, but the ethyl alcohol extract had a slightly bitter taste and a pungent flavor. This is because various nutraceutical materials such as carotenoids, polyphenol compounds, flavonoid compounds, etc., except starch, were extracted by ethyl alcohol.

3-5. Physicochemical Characteristics and Extraction Yield of Dried Hip Extract

Extraction was performed until soluble solids were no longer increased by the above-described extraction method, vacuum filtration was carried out, and the physicochemical characteristics of the extract by extraction solvent were examined. The pH, sugar content, acidity, chromaticity and extraction yield of the final extract were as shown in Table 6 below.

TABLE 6
Physicochemical characteristics and extraction yields of extracts

| | | Sugar | | | | | Extraction |
|---|---|---|---|---|---|---|---|
| | | content | Acidity | Chromaticity | | | yield |
| | pH | (° Bx) | (%) | L | a | b | (%) |
| Water extract | 4.12 | 5.3 | 0.27 | 27.97 ± 1.13 | 2.42 ± 0.52 | 1.66 ± 0.49 | 51.6 |
| Ethyl alcohol extract | 4.92 | 2.7 | 0.27 | 33.15 ± 0.46 | 8.20 ± 0.08 | 8.74 ± 0.09 | 55.7 |

In Table 6, the water extract of the Rosa rugosa Thunb. hips had a pH of 4.12, a sugar content of 5.3° Bx, an acidity of 0.27, and an extraction yield of 51.6%. The ethyl alcohol extract had a pH of 4.92, a sugar content of 2.7° Bx, an acidity of 0.27, and an extraction yield of 55.7%. The pH of the water extract was slightly lower than that of the ethyl alcohol extract, and it is assumed that this is because more materials affecting a decrease in pH, such as organic acids, were extracted. The sugar content of the water extract was approximately two-fold higher than that of the ethyl alcohol extract, and it is assumed that this is because more aqueous materials such as sugars, organic acids and starches were extracted by heating. The acidity was 0.27%, which is the same for both treatments. In terms of the chromaticity, the water extract had an L value (white chromaticity) of 27.97±1.13, an a value (red chromaticity) of 2.42±0.52, and a b value (yellow chromaticity) of 1.66±0.49, and the ethyl alcohol extract had an L value of 33.15±0.46, an a value of 8.20±0.08, and an b value of 8.74±0.09. The overall chromaticity of the water extract was higher than that of the ethyl alcohol extract, and it is assumed that this was because many more colors which are well dissolved in ethyl alcohol were extracted. The extraction yield of the water extract was evaluated by sugar content, which was approximately two-fold higher than that of the ethyl alcohol extract.

### EXAMPLE 4

Experiment of Development of Proper Mixing Ratios for Producing Beverage

4-1. Acidity Adjustment

It was determined that the acidity of the extract previously extracted with water was approximately 0.3%, and therefore no additional acidulant such as citric acid is needed.

4-2. Sugar Content Adjustment

To suitably mix an acidic taste and a sweet taste in the water extract, when the sugar content was adjusted to approximately 11.5° Bx with high fructose, the preference was high.

4-3. Test for Selecting Flavor

To select a suitable flavor for a Rosa rugosa Thunb. beverage, 0.1% of a liquid flavor such as a caramel flavor, a pineapple flavor, a grape flavor, a strawberry flavor, a lemon flavor, a citron flavor, a black tea flavor, an apple flavor A or B was added for a test, and sensory characteristics of each treatment is shown in Table 7.

TABLE 7
Test for selecting flavor for Rosa rugosa Thunb. beverage

| Flavor | Preference | Flavor characteristic |
|---|---|---|
| Caramel flavor | + | Strong caramel flavor, but not |
| | | characteristic |
| Pineapple flavor | ++ | Fresh pineapple flavor, but not |
| | | very appropriate |
| Grape flavor | + | Very strong grape flavor |
| Strawberry flavor | + | Very strong strawberry flavor |
| Lemon flavor | +++ | Well harmonized with the flavor |
| | | of Rosa rugosa Thunb. hip |
| | | extract and giving fresh flavor |
| Citron flavor | ++ | Imparting sweet citron flavor |
| | | but not characteristic |
| Black tea flavor | +++ | Imparting mild black tea flavor, |
| | | appropriate |
| Apple flavor A | + | Very strong apple flavor |
| Apple flavor B | ++ | Slightly strong apple flavor |

* +; not bad, ++; good, +++; very good

### EXAMPLE 5

Production of Rosa rugosa Thunb. Beverages: Mixing of Rosa rugosa Thunb. Extract With Supplementary Ingredients

5-1. Test of Mixing Rosa rugosa Thunb. Extract With Supplementary Materials

Table 8 shows mixing ratios of a Rosa rugosa Thunb. extract and high fructose, citric acid, flavors (lemon flavor and black tea flavor) and purified water.

TABLE 8
Mixing ratios of Rosa rugosa Thunb. extract beverages (units: g)

| | Mixing | Mixing | Mixing | Mixing |
|---|---|---|---|---|
| Material name | ratio-1 | ratio-2 | ratio-3 | ratio-4 |
| Extract (5° Bx) | 100 | 50 | 25 | 10 |
| High fructose | 6.5 | 8.5 | 9.7 | 10.5 |
| Citric acid | — | 0.1 | 0.2 | 0.25 |
| Flavor (lemon flavor) | 0.005 | 0.0025 | 0.002 | 0.002 |
| Flavor (black tea | 0.005 | 0.0025 | 0.001 | 0.001 |
| flavor) | | | | |
| Purified water | 0 | 50 | 75 | 90 |

5-2. Sensory Evaluation of Beverages Prepared by Mixing Rosa rugosa Thunb. Extract and Supplementary Materials

Table 9 shows the result of sensory evaluation for beverages prepared by mixing a Rosa rugosa Thunb. extract and supplementary materials. It can be seen that the beverage prepared by mixing the extract and the purified water at a ratio of 50:50, and adding 8.5 g of high fructose, 0.1 g of citric acid and 0.0025 g of each of the flavors thereto was most preferable in all aspects.

TABLE 9
-Sensory evaluation for beverages prepared by mixing
Rosa rugosa Thunb. extract and supplementary materials

| | Mixing | Mixing | Mixing | Mixing |
|---|---|---|---|---|
| Characteristic | ratio-1 | ratio-2 | ratio-3 | ratio-4 |
| Color | 7.5 | 7.2 | 6.8 | 6.5 |
| Flavor | 6.8 | 7.5 | 7.1 | 7.0 |
| Taste | 6.9 | 7.8 | 7.2 | 7.0 |
| Overall preference | 7.0 | 7.7 | 7.1 | 6.9 |

5-3. Physicochemical Characteristics of Beverage Prepared by Mixing Rosa rugosa Thunb. Extract and Supplementary Materials

Table 10 shows the physicochemical characteristics of a beverage prepared by mixing a Rosa rugosa Thunb. extract and supplementary materials. The four treatments resulted in a sugar content of 11.4 to 11.5° Bx, an acidity 0.29 to 0.3% and a pH of 3.9 to 4.1, and thus had no significant difference in these characteristics.

TABLE 10
Physicochemical characteristics of beverages prepared by mixing
Rosarugosa Thunb. extract and supplementary materials

| | Mixing | Mixing | Mixing | Mixing |
|---|---|---|---|---|
| Characteristic | ratio-1 | ratio-2 | ratio-3 | ratio-4 |
| Sugar content | 11.5 | 11.4 | 11.5 | 11.4 |
| (° Bx) | | | | |
| Acidity (%) | 0.3 | 0.29 | 0.3 | 0.28 |
| pH | 4.1 | 4.0 | 3.9 | 4.0 |

5-4. Test Product of Beverage Prepared by Mixing Rosa rugosa Thunb. Extract and Supplementary Materials

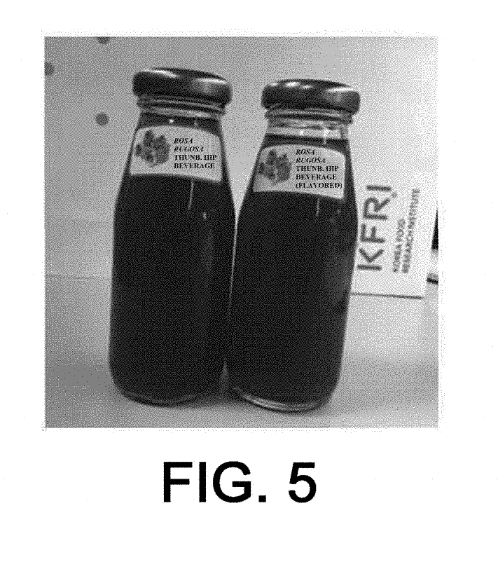

FIG. 5 shows Rosa rugosa Thunb. beverages using a Rosa rugosa Thunb. extract.

### EXAMPLE 6

Production of Rosa rugosa Thunb. Beverages: Mixing of Rosa rugosa Thunb. Extract and Oriental Medicinal Materials

6-1. Test of Mixing Rosa rugosa Thunb. Extract and Oriental Medicinal Materials

Table 11 shows mixing ratios of pouch-type Rosa rugosa Thunb. beverages prepared by mixing a Rosa rugosa Thunb. extract with dry jujube, dry ginger and licorice.

TABLE 11
Beverages prepared by mixing Rosa rugosa Thunb.
and oriental medicinal materials (units: g)

| | Mixing | Mixing | Mixing | Mixing |
|---|---|---|---|---|
| Material name | ratio-1 | ratio-2 | ratio-3 | ratio-4 |
| Extract (5° Bx) | 100 | 100 | 100 | 100 |
| Dry jujube | 10 | 5 | 2.5 | 1.25 |
| Dry ginger | — | 1 | 0.5 | 0.25 |
| Licorice | — | 1 | 0.5 | 0.25 |

6-2. Sensory Evaluation for Beverages Prepared by Mixing Rosa rugosa Thunb. Extract and Oriental Medicinal Materials

Table 12 shows the result of sensory evaluation for beverages prepared by mixing a Rosa rugosa Thunb. extract and oriental medicinal materials. It can be seen from the test for sensory evaluation that the beverage prepared by mixing the extract with 5 g of dry jujube, 1 g of dry ginger, and 1 g of licorice is most preferable.

TABLE 12
Sensory evaluation for beverage prepared by mixing Rosa rugosa
Thunb. extract and oriental medicinal materials

| | Mixing | Mixing | Mixing | Mixing |
|---|---|---|---|---|
| Characteristic | ratio-1 | ratio-2 | ratio-3 | ratio-4 |
| Color | 7.5 | 7.2 | 6.8 | 6.5 |
| Flavor | 6.8 | 7.5 | 7.1 | 7.0 |
| Taste | 6.9 | 7.8 | 7.2 | 7.0 |
| Overall preference | 7.0 | 7.7 | 7.1 | 6.9 |

6-3. Physicochemical Characteristics of Beverages Prepared by Mixing Rosa rugosa Thunb. Extract and Supplementary Materials

Table 13 shows the physicochemical characteristics of beverages prepared by mixing Rosa rugosa Thunb. extract and supplementary materials. The four treatment showed no significant difference in sugar content, acidity and pH.

TABLE 13
Physicochemical characteristics of pouch-type beverages

| | Mixing | Mixing | Mixing | Mixing |
|---|---|---|---|---|
| Characteristic | ratio-1 | ratio-2 | ratio-3 | ratio-4 |
| Sugar content | 11.5 | 11.4 | 11.5 | 11.4 |
| (° Bx) | | | | |
| Acidity (%) | 0.3 | 0.29 | 0.3 | 0.28 |
| pH | 4.1 | 4.0 | 3.9 | 4.0 |

6-4. Test Products of Pouch-Type Rosa rugosa Thunb. Beverages

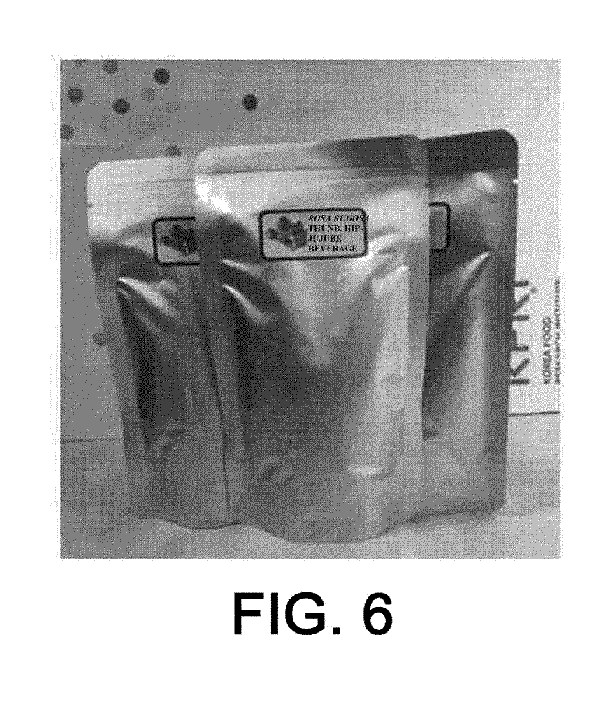

FIG. 6 shows pouch-type beverages prepared by mixing a Rosa rugosa Thunb. extract with dry jujube, dry ginger and licorice.

### EXAMPLE 7

Production of Rosa rugosa Thunb. Beverages: Test for Producing Tea Bag-Type Rosa rugosa Thunb. Tea

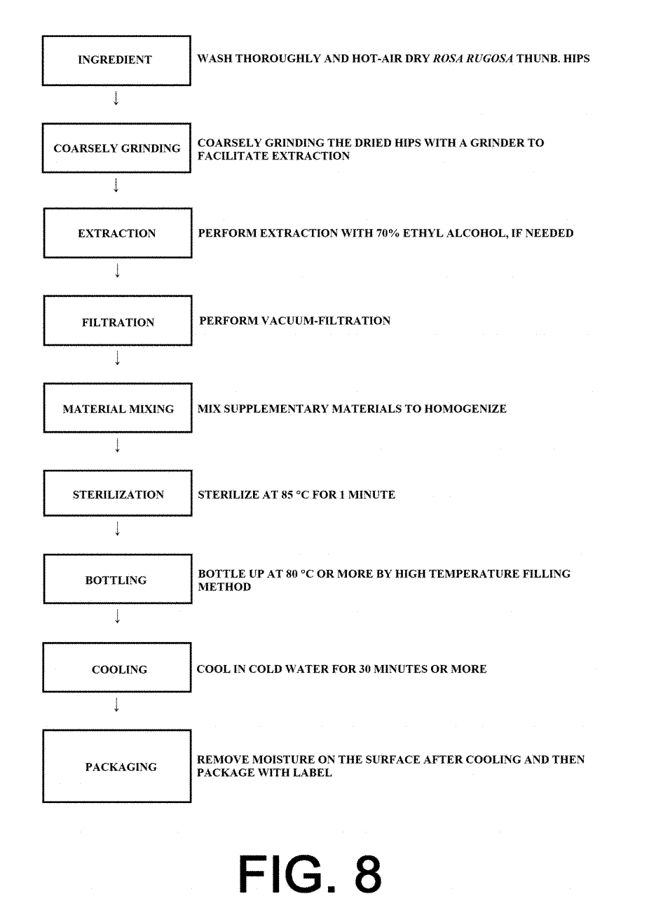

To produce tea bag-type Rosa rugosa Thunb. tea, dried Rosa rugosa Thunb. was ground, samples were collected using test sieves, 10 mesh (mesh size: 2.00 mm) and 16 mesh (mesh size: 1.18 mm), and then 1.5 g of each of the samples was put into a tea filter. To mask the sour and bitter tastes of Rosa rugosa Thunb., licorice was ground and mixed. In this case, approximately 1.4 g of the dried Rosa rugosa Thunb. and 0.1 g of licorice were added. Treatment A was prepared by mixing hot-air dried Rosa rugosa Thunb. and licorice, and Treatment B was prepared by mixing lyophilized Rosa rugosa Thunb. and licorice, and they were produced in the form of Rosa rugosa Thunb. leached tea (FIG. 8). It was evaluated that the higher leaching temperature, the more sour and bitter tastes of Rosa rugosa Thunb. Therefore, one tea bag was put into a cup, 100 mL of approximately 80□ water was poured into the cup, 1 to 2 minutes later, the tea bag was stirred several times, and then the tea was ready to drink.

### EXAMPLE 8

Process of Producing Rosa rugosa Thunb. Beverage

Rosa rugosa Thunb. hips were washed thoroughly, hot-air dried at 50□, coarsely ground, and then reflux-extracted with water or 70% ethyl alcohol. The extract was vacuum-filtrated, mixed with supplementary materials required for producing a beverage, and homogenized. The homogenate was sterilized at 85□ for 1 minute, bottled up by a high-temperature filling method, cooled and stored (FIG. 8).

A food composition and a beverage, each including a Rosa rugosa Thunb. extract of the present invention, are expected to have high preference and a high nutraceutical property, and contribute to the increase in local income through industrial production.

1. A method for preparing a food composition including a Rosa rugosa Thunb. hip extract, comprising:
i) washing Rosa rugosa Thunb. hips with water and hot-air drying the washed hips;
ii) coarsely grinding the hot-air dried Rosa rugosa Thunb. hips prepared in Step i);
iii) obtaining a Rosa rugosa Thunb. hip extract by extracting and concentrating the coarsely ground Rosa rugosa Thunb. hips prepared in Step ii) with a solvent; and
iv) preparing a homogenized and mixed beverage by adding supplementary materials including high fructose, citric acid, a flavor and purified water to the Rosa rugosa Thunb. hip extract obtained in Step iii).

2. The method according to claim 1, wherein the solvent in Step iii) is water, ethyl alcohol or a mixture thereof.

3. The method according to claim 1, wherein the concentration in Step iii) is concentration of the extract until a sugar content becomes 2 to 6 Bx.

4. The method according to claim 1, wherein the supplementary material in Step iv) includes 5 to 120 parts by weight of high fructose, 0.1 to 3 parts by weight of citric acid, 0.01 to 0.05 part by weight of a flavor, and 50 to 1000 parts by weight of purified water with respect to 100 parts by weight of the Rosa rugosa Thunb. hip extract.

5. The method according to claim 1, wherein the flavor in Step iv) includes any one or more selected from the group consisting of a pineapple flavor, a lemon flavor, a citron flavor, a black tea flavor and an apple flavor.

6. A method for preparing a food composition including a Rosa rugosa Thunb. hip extract, the method comprising:
i) washing Rosa rugosa Thunb. hips with water and hot-air drying the washed hips;
ii) coarsely grinding the hot-air dried Rosa rugosa Thunb. hips prepared in Step i);
iii) obtaining a Rosa rugosa Thunb. hip extract by extracting and concentrating the coarsely ground Rosa rugosa Thunb. hips prepared in Step ii) with a solvent; and
iv) preparing a homogenized and mixed beverage by adding oriental medicinal materials such as including dry jujube, dry ginger and licorice to the Rosa rugosa Thunb. hip extract obtained in Step iii).

7. The method according to claim 6, wherein the solvent in Step iii) is water, ethyl alcohol or a mixture thereof.

8. The method according to claim 6, wherein the oriental medicinal materials in Step iv) include 1 to 10 parts by weight of dry jujube, 0.1 to 1.5 parts by weight of dry ginger, and 0.1 to 1.5 parts by weight of licorice with respect to 100 parts by weight of the Rosa rugosa Thunb. hip extract.

9. A Rosa rugosa Thunb. food composition prepared by the method according to claim 1.

10. The composition according to claim 9, which is a beverage composition or produced in the form of a pouch-type tea bag.
